(19) United States
(12) Patent Application Publication
(10) Pub. No.: US 2025/0118202 A1
(43) Pub. Date: Apr. 10, 2025

(54) SYSTEMS AND METHODS FOR PREDICTING TRAFFIC SIGNAL PHASE AND TIMING

(71) Applicant: Ford Global Technologies, LLC, Dearborn, MI (US)

(72) Inventors: Shreshta Rajakumar Deshpande, Ann Arbor, MI (US); Kukhyun Ahn, Ann Arbor, MI (US); Xiaowu Zhang, Novi, MI (US); Yan Wang, Ann Arbor, MI (US); Xinpeng Wang, Dearborn, MI (US); Han Zheng, Dearborn, MI (US); Huei Peng, Dearborn, MI (US)

(21) Appl. No.: 18/482,962

(22) Filed: Oct. 9, 2023

(51) Int. Cl. G08G 1/0967; G06N 20/20; G08G 1/01; G08G 1/052; G08G 1/056

(52) U.S. Cl. CPC G08G 1/096775; G06N 20/20; G08G 1/0116; G08G 1/0129; G08G 1/0141; G08G 1/0145; G08G 1/052; G08G 1/056; G08G 1/096725

(57) ABSTRACT

A traffic signal phase and timing (SPaT) prediction system is disclosed. The system may include a transceiver configured to receive historical traffic signal information associated with a traffic light and real-time traffic signal information. The system may further include a memory configured to store a training data and a trained machine model. The trained machine model may be trained using the training data that includes the historical traffic signal information. The system may further include a processor configured to execute instructions stored in the trained machine model to predict traffic signal information (e.g., SPaT) associated with a future traffic signal cycle based on the real-time traffic signal information. The processor may further output the traffic signal information associated with the future traffic signal cycle to a vehicle.

### FIELD

The present disclosure relates to systems and methods for predicting traffic signal phase and timing for a traffic light based on historical and real-time traffic signal information.

### BACKGROUND

It is known that vehicles expend considerable amount of fuel and/or battery charge at traffic lights when the traffic signal phase is red or yellow. Significant increase in vehicle operational efficiency may be achieved if the vehicles spend less time waiting at the traffic lights for the traffic signal phase to turn green, or if the vehicles cross the traffic lights when the traffic signal phase is green.

To achieve greater vehicle operational efficiency, it is imperative to accurately predict traffic signal phase and timing (SPaT) associated with the traffic lights. Conventional SPaT prediction systems are able to predict SPaT when the traffic lights operate on fixed schedule; however, the conventional systems have limited utility in predicting SPaT for traffic lights that actuate dynamically based on traffic conditions.

Therefore, a system is required that accurately predicts SPaT for dynamically actuated traffic lights.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of an example traffic signal phase and timing (SPaT) prediction system and a vehicle in accordance with the present disclosure.

FIG. 3 depicts a schematic diagram of a trained machine module in accordance with the present disclosure.

FIG. 4 depicts an example message being displayed on a vehicle infotainment system in accordance with the present disclosure.

FIG. 5 depicts a flow diagram of an example method for predicting SPaT in accordance with the present disclosure.

### DETAILED DESCRIPTION

### Overview

The present disclosure describes a traffic signal phase and timing (SPaT) prediction system configured to predict traffic signal information, e.g., SPaT, associated with a traffic light for a future (e.g., next) traffic signal cycle. The system may predict the SPaT information for the future traffic signal cycle based on historical and real-time traffic signal information associated with the traffic light. The historical traffic signal information may be SPaT information associated with the traffic light for a predefined past time duration or a first predefined count of traffic signal cycles. The real-time traffic signal information may be SPaT information associated with the traffic light for a second predefined count of “recent” traffic signal cycles. The first predefined count may be substantially greater than the second predefined count.

The system may include a trained machine module that may be trained using the historical traffic signal information and a supervised machine learning algorithm (e.g., Gaussian Process Regression (GPR) supervised machine learning algorithm). The system may input the real-time traffic signal information to the trained machine module to output the predicted SPaT information for the future traffic signal cycle.

In an exemplary aspect, the SPaT information for the future traffic signal cycle may include an expected timing or time duration for the green phase and the red phase for the traffic light, and an expected total time duration for the future traffic signal cycle. Responsive to predicting the SPaT information for the future traffic signal cycle, the system may transmit the SPaT information to a vehicle.

The vehicle may obtain the SPaT information from the system, and may control vehicle movement based on the SPaT information and real-time vehicle information (e.g., a current vehicle speed towards the traffic light, a vehicle geolocation, etc.). For example, based on the SPaT information, real-time vehicle information and a geolocation of the traffic light, the vehicle may determine whether the vehicle may arrive at the traffic light in green phase or red phase. Responsive to determining that the vehicle may not arrive at the traffic light in the green phase at the current vehicle speed, the vehicle may modify (e.g., increase or decrease) the vehicle speed, or maintain its current speed, such that the vehicle may cross the traffic light in the green phase.

The present disclosure discloses a system that assists a vehicle in crossing a traffic light in green phase, thereby conserving vehicle energy that may have been spent if the vehicle were to wait at the traffic light in red phase. Further, the system predicts the SPaT information for the future traffic signal cycle based on both historical and real-time traffic signal information; therefore, the prediction is more accurate than the predictions output by conventional SPaT prediction systems.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

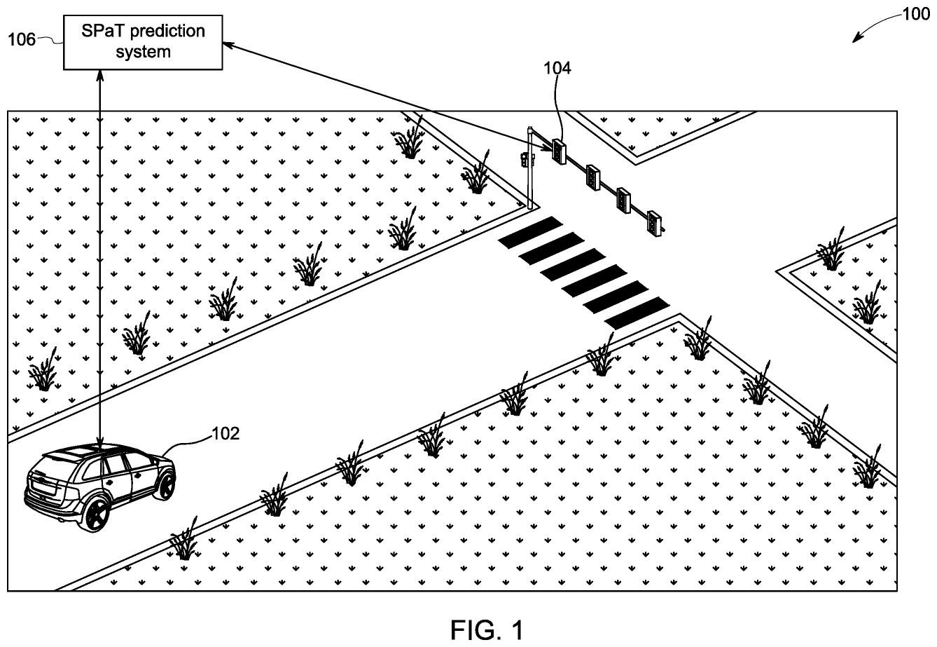

FIG. 1 depicts an example environment 100 in which techniques and structures for providing the systems and methods disclosed herein may be implemented. The environment 100 may include a vehicle 102 that may be travelling on a road including one or more traffic lights 104 (or traffic light 104). The vehicle 102 may take the form of any passenger or commercial vehicle such as, for example, a car, a work vehicle, a crossover vehicle, a truck, a van, a minivan, a taxi, a bus, etc. The vehicle 102 may be a manually driven vehicle, and/or may be configured to operate in a partially or fully autonomous mode, and may include any powertrain such as, for example, a gasoline engine, one or more electrically-actuated motor(s), a hybrid system, etc.

The traffic light 104 may be configured to operate on a fixed schedule or may be dynamically actuated by a traffic light control server (not shown) based on traffic, weather, etc. conditions on the road in proximity to the traffic light 104. In some aspects, when the traffic light 104 operates on a fixed schedule, actuation of a traffic signal phase (e.g., a green phase when the traffic light 104 emits green light, a yellow phase when the traffic light 104 emits yellow light, or a red phase when the traffic light 104 emits red light) may follow a fixed time schedule. For example, when the traffic light 104 operates on a fixed schedule, the traffic light 104 may be in the green phase for 90 seconds, followed by the yellow phase for 5 seconds, and then the red phase for 60 seconds. In this case, the timing or time duration of each phase (e.g., 90 seconds for green phase, 5 seconds for yellow phase and 60 seconds for red phase) remains constant or fixed, irrespective of a flow of traffic or vehicles on the road. Further, a total time duration of a “traffic signal cycle” may also remain constant in this case. In some aspects, the traffic signal cycle, as described in the present disclosure, means a cycle of traffic light operation that starts with the commencement of a green phase and ends at the beginning of a next green phase. Continuing with the example described below, the total time duration for a traffic signal cycle associated with the traffic light 104 may be 155 seconds (i.e., a sum of 90+60+5 seconds), when the traffic light 104 may be operating on a fixed schedule.

On the other hand, when the traffic light 104 may be dynamically actuated (e.g., by the traffic light control server) based on traffic on the road, actuation of a traffic signal phase (i.e., the green phase, the red phase or the yellow phase) may not follow a fixed pattern. Further, a time duration for which the traffic light 104 may operate in each phase may also not be fixed. Furthermore, in this case, the total time duration of a traffic signal cycle may or may not be fixed. For the description of the present disclosure, the traffic light 104 is assumed to be a dynamically actuated traffic light. Further, for the sake of simplicity, red phase and yellow phase are considered as red phase.

In addition to the vehicle 102 and the traffic light 104, the environment 100 may further include a traffic signal phase and timing (SPaT) prediction system 106 (system 106). The system 106 may part of the vehicle 102 or may be a separate system hosted on a server (not shown). If the system 106 is hosted on a server, the system 106 may be communicatively coupled with the vehicle 102, as shown in FIG. 1.

The system 106 may be an Artificial Intelligence/Machine Learning (AI/ML) based system that may be configured to predict traffic signal information associated with future traffic signal cycles for a plurality of traffic lights (including the traffic light 104). Specifically, the system 106 may be an AI/ML based system that may be configured to predict information associated with SPaT for a future traffic signal cycle for the traffic light 104, based on historical traffic signal information and real-time traffic signal information associated with the traffic light 104. For example, the system 106 may predict a total time duration, the pattern of actuation of phases, and timing or time duration associated with each phase for the future (e.g., next) traffic signal cycle of the traffic light 104, based on historical and real-time traffic signal information associated with the traffic light 104. Responsive to predicting the SPaT information for the future traffic signal cycle, the system 106 may transmit the SPaT information to the vehicle 102. The vehicle 102 may use the SPaT information to increase or reduce vehicle speed, travel direction, etc. such that the vehicle 102 may cross the traffic light 104 when the traffic light 104 may operating in the green phase. In this manner, the vehicle 102 may not be required to stop at the traffic light 104, thereby conserving energy that may have been spent waiting at the traffic light 104.

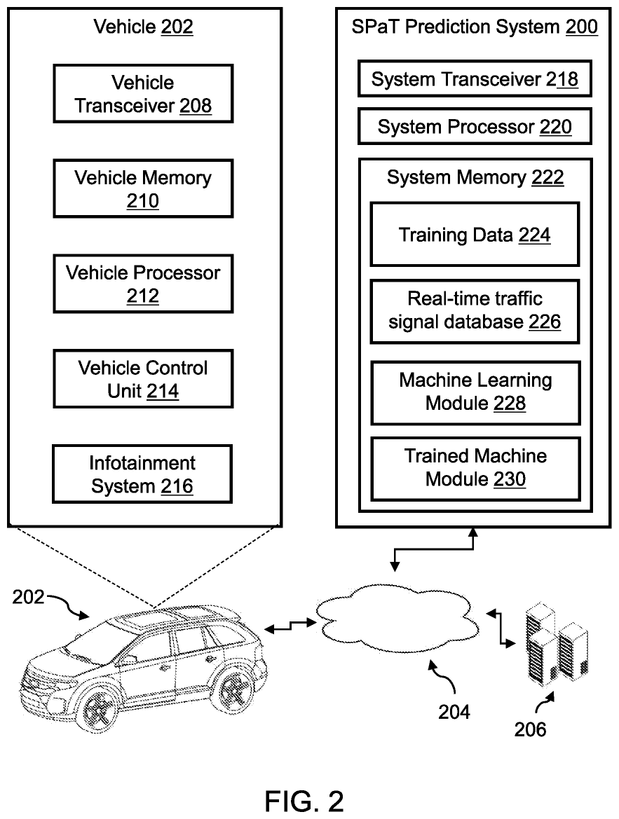

In some aspects, the system 106 may use the historical traffic signal information associated with the traffic light 104 as training data and a supervised machine learning algorithm (e.g., Gaussian Process Regression (GPR) supervised machine learning algorithm) to generate a trained machine learning module. The historical traffic signal information may be SPaT information associated with the traffic light 104 for a predefined past time duration (e.g., past 3 months, 6 months, 12 months, etc.) or a first predefined count of past traffic signal cycles (e.g., 10000, 15000, 25000, etc. cycles). As an example, the historical traffic signal information may include information associated with total time duration of each historical traffic signal cycle, timings or time duration for each phase (green and red) in the historical traffic signal cycle, and/or the like. Responsive to generating the trained machine learning module, the system 106 may store the trained machine learning module in a system memory (shown as system memory 222 in FIG. 2).

The system 106 may be further configured to obtain the real-time traffic signal information from the traffic light control server and/or a traffic light controller (not shown) installed in the traffic light 104. In some aspects, the real-time traffic signal information may be SPaT information associated with the traffic light 104 for a second predefined count of “recent” traffic signal cycles (e.g., recent 5 or 10 traffic light cycles). As apparent from the description above, the first predefined count of past traffic signal cycles may be substantially greater than the second predefined count of “recent” traffic signal cycles.

Responsive to obtaining the real-time traffic signal information, the system 106 may execute instructions stored in the trained machine learning module and the real-time traffic signal information to predict the information associated with SPaT for the future traffic signal cycle for the traffic light 104. The system 106 may then transmit this information to the vehicle 102, which may control vehicle movement based on the received information. For example, if the vehicle 102 is an autonomous vehicle, the vehicle 102 may automatically control vehicle moved based on the received SPaT information such that the vehicle 102 may cross the traffic light 104 when the phase may be green. On the other hand, if the vehicle 102 is a manually driven vehicle or a partially autonomous vehicle, the vehicle 102 may display a vehicle movement recommendation on a vehicle infotainment system (shown as infotainment system 216 in FIG. 2.) based on the received SPaT information. The vehicle movement recommendation may include recommendation to either increase or decrease the vehicle speed to assist the vehicle 102 in crossing the traffic light 104 in the green phase. A vehicle driver (not shown) may view or hear the vehicle movement recommendation on the vehicle infotainment system, and may accordingly control vehicle movement.

Further details of the system 106 and the vehicle 102 are described below in conjunction with FIG. 2.

The vehicle 102, the system 106 and the vehicle driver implement and/or perform operations, as described here in the present disclosure, in accordance with the owner manual and safety guidelines. In addition, any action taken by the vehicle or the vehicle driver should comply with all the rules specific to the location and operation of the vehicle 102 (e.g., Federal, state, country, city, etc.). The notifications or recommendations, as provided by the vehicle 102 or the system 106, should be treated as suggestions and only followed according to any rules specific to the location and operation of the vehicle 102.

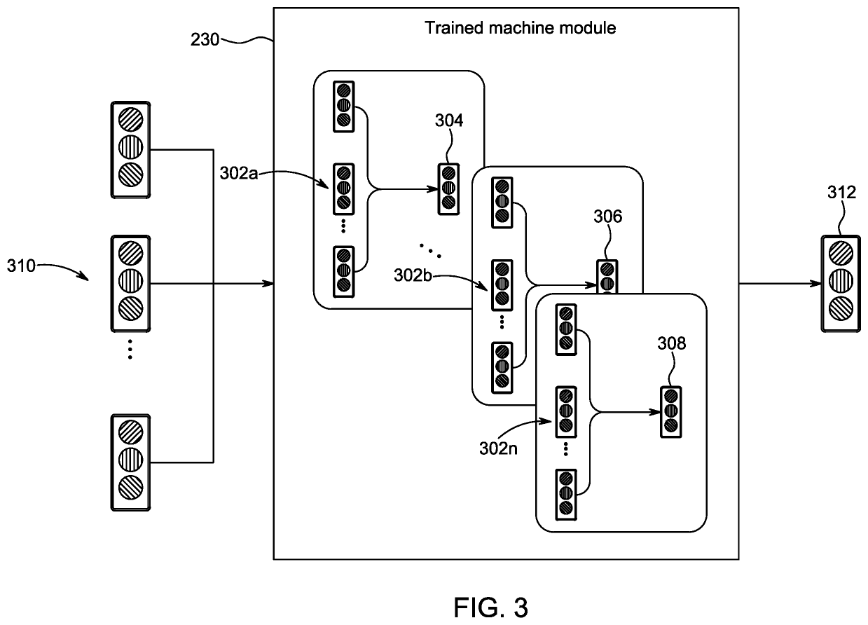

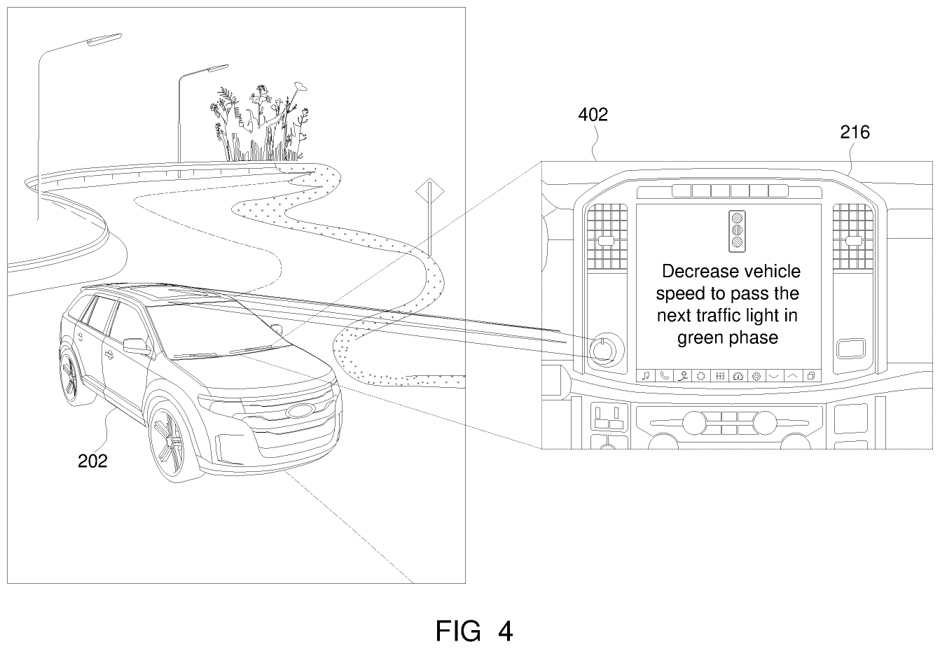

FIG. 2 depicts a block diagram of an example traffic signal phase and timing (SPaT) prediction system 200 (system 200) and a vehicle 202 in accordance with the present disclosure. The system 200 may be same as the system 106 and the vehicle 202 may be same as the vehicle 102 described above in conjunction with FIG. 1. While describing FIG. 2, references will be made to FIGS. 3 and 4.

The system 200 and the vehicle 202 may be communicatively coupled with each other via one or more networks 204 (or network 204). The system 200 and the vehicle 202 may further communicatively couple with one or more servers 206 (or server 206) via the network 204. In some aspects, the server 206 may be part of a cloud-based computing infrastructure and may be associated with and/or include a Telematics Service Delivery Network (SDN) that provides digital data services to the vehicle 202 and other vehicles (not shown in FIG. 2) that may be part of a commercial vehicle fleet. In further aspects, the server 206 may be a traffic light control server that may be configured to store historical traffic signal information associated with a plurality of traffic lights (including the traffic light 104), and transmit the historical traffic signal information to the system 200 at a predefined frequency or when the system 200 transmits a request to the server 206 to fetch/obtain the historical traffic signal information. The server 206 may be further configured to determine real-time traffic signal information associated with the plurality of traffic lights (including the traffic light 104), and transmit the real-time traffic signal information to the system 200 when the system 200 transmits a request to the server 206 to fetch/obtain the real-time traffic signal information. The concept of historical traffic signal information and real-time traffic signal information is already described above in conjunction with FIG. 1. In some aspects, the server 206 may transmit the historical traffic signal information and the real-time traffic signal information associated with the traffic light 104 to the system 200 via the network 204.

The network 204 illustrates an example communication infrastructure in which the connected devices discussed in various embodiments of this disclosure may communicate. The network 204 may be and/or include the Internet, a private network, public network or other configuration that operates using any one or more known communication protocols such as, for example, transmission control protocol/Internet protocol (TCP/IP), Bluetooth®, BLE, Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 202 may include a plurality of units including, but not limited to, a vehicle transceiver 208, a vehicle memory 210, a vehicle processor 212, a vehicle control unit (VCU) 214, an infotainment system 216, and/or the like, which may be communicatively coupled with each other. The vehicle transceiver 208 may be configured to receive/transmit data/information/signals from/to external systems and devices via the network 204. For example, the vehicle transceiver 208 may transmit or receive information/signals to/from the system 200 and/or the server 206. The vehicle transceiver 208 may be further configured to transmit/receive signals/information to/from the vehicle units described above.

The VCU 214 may include a plurality of Electronic Control Units (ECUs, not shown) and/or a plurality of vehicle sensors (not shown) that may enable the VCU 214 to control vehicle operational aspects and implement one or more instruction sets received from the vehicle processor 212. For example, the VCU 214 may control vehicle speed, vehicle's direction of motion, etc., when the vehicle 202 may be a fully or a partially autonomous vehicle. The VCU 214 may be further configured to determine real-time vehicle information. In some aspects, the real-time vehicle information may include real-time (or current) vehicle speed, a vehicle movement direction, a vehicle geolocation, and/or the like.

The vehicle processor 212 may be disposed in communication with one or more memory devices disposed in communication with the respective computing systems (e.g., the vehicle memory 210 and/or one or more external databases not shown in FIG. 2). The vehicle processor 212 may utilize the vehicle memory 210 to store programs in code and/or to store data for performing aspects in accordance with the disclosure. The vehicle memory 210 may be a non-transitory computer-readable storage medium or memory storing program codes that may enable the vehicle processor 212 to perform operations as per the present disclosure. The vehicle memory 210 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The infotainment system 216 may include a touchscreen interface portion, and may include voice recognition features, biometric identification capabilities that can identify users based on facial recognition, voice recognition, fingerprint identification, or other biological identification means. In other aspects, the infotainment system 216 may be further configured to receive user instructions via the touchscreen interface portion, and/or output or display notifications (including visual and/or audible alert notifications), navigation maps, recommendations, messages, etc. on the touchscreen interface portion.

The system 200 may include a plurality of units including, but not limited to, a system transceiver 218, a system processor 220 and a system memory 222. The system transceiver 218 may be configured to receive/transmit information/signals from/to external systems or devices via the network 204. For example, the system transceiver 218 may receive/transmit information/signals from/to the vehicle 202 and the server 206.

The system processor 220 may utilize the system memory 222 to store programs in code and/or to store data for performing operations in accordance with the present disclosure. The system memory 222 may be a non-transitory computer-readable storage medium or memory storing the program codes that may enable the system processor 220 to perform operation in accordance with the present disclosure. In some aspects, the system memory 222 may include a plurality of databases and modules including, but not limited to, a training data database 224 (or training data 224), a real-time traffic signal information database 226 (or real-time traffic signal database 226), a machine learning module 228 and a trained machine module 230. The functions of these memory databases and modules may be understood in conjunction with the description provided below.

In operation, the system transceiver 218 may receive the historical traffic signal information associated with the traffic light 104 from the server 206 via the network 204. In some aspects, the system transceiver 218 may receive the historical traffic signal information from the server 206 when the system processor 220 transmits, via the system transceiver 218, a request to fetch/obtain the historical traffic signal information to the server 206. The system transceiver 218 may additionally receive a geolocation of the traffic light 104 from the server 206. The system transceiver 218 may transmit the traffic light geolocation to the system memory 222 for storage purpose.

Responsive to obtaining the historical traffic signal information associated with the traffic light 104, the system transceiver 218 may transmit the historical traffic signal information to the training data 224 for storage purpose. Stated another way, the training data 224 may include the historical traffic signal information associated with the traffic light 104.

In some aspects, the system processor 220 may be an AI/ML based processor that may generate the trained machine module 230 by using the training data 224 (i.e., the historical traffic signal information) and a supervised machine learning algorithm pre-stored in the machine learning module 228. In an exemplary aspect, the supervised machine learning algorithm may be a Gaussian Process Regression (GPR) supervised machine learning algorithm. Responsive to generating the trained machine module 230, the system processor 220 may execute the instructions stored in the trained machine module 230 to “predict” traffic signal information or SPaT information for a future traffic signal cycle associated with the traffic light 104, by using the real-time traffic signal information as an input. Stated another way, when the trained machine module 230 may be generated, the system processor 220 may obtain the real-time traffic signal information from the server 206 and input the real-time traffic signal information to the trained machine module 230 to predict the SPaT information for a future traffic signal cycle.

A person ordinarily skilled in the art may appreciate that machine learning is an application of Artificial Intelligence (AI) using which systems or processors (e.g., the system processor 220) may have the ability to automatically learn and enhance from experience without being explicitly programmed. Machine learning focuses on use of data and algorithms to imitate the way humans learn. In some aspects, the machine learning algorithms may be created to make classifications and/or predictions. Machine learning based systems may be used for a variety of applications including, but not limited to, speech recognition, image or video processing and statistical analysis, probability determination, traffic signal phase and timing determination, and/or the like.

Machine learning may be of various types based on data or signals available to the learning system. For example, the machine learning approach may include supervised learning, unsupervised learning, semi-supervised learning, or reinforcement learning. The supervised learning is an approach that may be supervised by a human. In this approach, the machine learning algorithm may use labeled training data (e.g., the training data 224) and defined variables. In the case of supervised learning, both the input and the output of the algorithm may be specified/defined, and the algorithms may be trained to classify data and/or predict outcomes accurately.

Broadly, the supervised learning may be of two types, “regression” and “classification”. In classification learning, the learning algorithm may help in dividing the dataset into classes based on different parameters. In this case, a computer program may be trained on the training dataset and based on the training, the computer program may categorize input data into different classes. Some known methods used in classification learning include Logistic Regression, K-Nearest Neighbors, Support Vector Machines (SVM), Kernel SVM, Naîve Bayes, Decision Tree Classification, and Random Forest Classification.

In regression learning, the learning algorithm may predict output value that may be of continuous nature or real value. Some known methods used in regression learning include Simple Linear Regression, Multiple Linear Regression, Polynomial Regression, Support Vector Regression, Decision Tree Regression, and Random Forest Regression. In the present disclosure, the machine learning module 228 may be based on Gaussian Process Regression (GPR) supervised machine learning algorithm, and the system processor 220 may execute the GPR supervised machine learning algorithm stored in the machine learning module 228 and the training data 224 (i.e., the historical traffic signal information) to generate the trained machine module 230.

The unsupervised learning is an approach that involves algorithms that may be trained on unlabeled data. An unsupervised learning algorithm may analyze the data by its own and find patterns in input data. Further, semi-supervised learning is a combination of supervised learning and unsupervised learning. A semi-supervised learning algorithm involves labeled training data; however, the semi-supervised learning algorithm may still find patterns in the input data. Reinforcement learning is a multi-step or dynamic process. This model is similar to supervised learning, but may not be trained using sample data. This model may learn “as it goes” by using trial and error. A sequence of successful outcomes may be reinforced to develop the best recommendation or policy for a given problem in reinforcement learning.

As described above, in the present disclosure, the system processor 220 uses regression based supervised learning algorithm to generate the trained machine module 230 by using the training data 224. Stated another way, the trained machine module 230 may be trained by using the training data 224. The system processor 220 may continuously modify and update the trained machine module 230 as new training data may be received by the system 200, to make the trained machine module 230 more accurate with time. Responsive to generating the trained machine module 230, the system processor 220 may store the trained machine module 230 in the system memory 222.

An example schematic of the trained machine module 230 is depicted in FIG. 3. SPaT information is depicted as a traffic light symbol in FIG. 3. In an exemplary aspect, as shown in FIG. 3, the trained machine module 230 may be trained by using multiple sets 302a, 302b, 302n of training data or historical traffic signal information. Specifically, while “training” or generating the trained machine module 230, the system processor 220 may execute the machine learning module 228 to “predict” SPaT information 304 associated with a future traffic signal cycle by using the set 302a, and may then compare the predicted SPaT information 304 with an actual SPaT information. Based on the comparison, the system processor 220 may determine an accuracy level of the machine module, and may fine-tune the module to enhance the accuracy. Further, responsive to fine-tuning, the system processor 220 may similarly cause the machine learning module 228 to predict SPaT information 306, 308 for future traffic signal cycles by using the sets 302b, 302n and perform the comparison as described above, till the accuracy level of the machine module may be above a predefined threshold. Responsive to determining that the accuracy level is above the predefined threshold, the system processor 220 may treat the machine module as “trained” and may store the trained machine module 230 in the system memory 222, as described above.

Responsive to generating and storing the trained machine module 230, the system processor 220 may obtain, via the system transceiver 218, the real-time traffic signal information associated with the traffic light 104 from the server 206 and/or a traffic light controller installed in the traffic light 104, via the network 204. Specifically, in this case, the system processor 220 may transmit, via the system transceiver 218, a request to the server 206 and/or the traffic light controller to obtain the real-time traffic signal information. Responsive to transmitting the request, the system transceiver 218 may receive the real-time traffic signal information, and may transmit the received information to the system processor 220 and to the real-time traffic signal database 226 for storage purpose.

Responsive to obtaining the real-time traffic signal information from the system transceiver 218, the system processor 220 may execute instructions stored in the trained machine module 230 to predict traffic signal information (i.e., SPaT information) associated with a future traffic signal cycle for the traffic light 104, based on the real-time traffic signal information. For example, as shown in FIG. 3, the system processor 220 may input real-time traffic signal information 310 (e.g., SPaT information for past 8 or 10 traffic signal cycles) associated with the traffic light 104 to the trained machine module 230, and execute the instructions stored in the trained machine module 230 to predict SPaT information 312 associated with a future (or next) traffic signal cycle. As an example, the system processor 220 may input timing and time duration associated with the green phase of the traffic light 104 for the past 10 traffic signal cycles to the trained machine module 230, and output predicted or estimated timing and time duration associated with the green phase of the traffic light 104 for a future (e.g., next) traffic signal cycle.

An example mathematical expression associated with the trained machine module 230 is illustrated below. The mathematical expression should not be construed as limiting the present disclosure scope, and is provided as an example expression that may be associated with the trained machine module 230. Any other mathematical expression may also be associated with the trained machine module 230, without departing from the scope of the present disclosure.

A Gaussian process (associated with the trained machine module 230) may be defined as: f(x)˜GP[m(x), k(x, x′)], where m(x) may be a mean function and k(x, x′) may be a covariance function for a pair (x, x′). Further, in an exemplary aspect, m(x)=E[f(x)] and k(x, x′)=E[(f(x)−m(x))(f(x′)−m(x′))], where E[X] denotes an expected value of X.

The example steps executed by the system processor 220 and/or the trained machine module 230 to model the SPaT information with Gaussian Process Regression may include a first step where the model or the trained machine module 230 may be formed (or “Model Formulation”), in which y=f(x), f(x)˜GP[m(x), k(x, x′|θ)], where y is the model and θ is the model parameter vector. The model parameter θ may be estimated with maximum likelihood.

As a second step, the n^{th} duration dⁿ (e.g., duration of green phase) may be predicted, according to the duration of the last “k” durations (d^{n-k}˜dⁿ⁻¹). In some aspects, the input to the model may be xₙ=[d^{n-k} . . . d^{n-k+1} . . . dⁿ⁻¹], and the output from the model may be Ŷₙ=Dⁿ. Further, as described above, the model may be trained with collated historical SPaT data D (or training dataset D), where D=[X, Y]. Here, X=[x¹, x², x³ . . . ] and Y=[y¹, y², y³].

Responsive to predicting the SPaT information 312 associated with the future traffic signal cycle, the system processor 220 may output/transmit, via the system transceiver 218, the SPaT information 312 to the vehicle transceiver 208 via the network 204. The system processor 220 may further transmit, via the system transceiver 218, the geolocation of the traffic light 104 (that the system 200 may have received from the server 206, as described above) to the vehicle transceiver 208.

The vehicle transceiver 208 may receive the SPaT information 312 and the traffic light geolocation from the system transceiver 218, and may transmit the received information to the vehicle memory 210 for storage purpose and to the vehicle processor 212. The vehicle processor 212 may obtain the SPaT information 312 and the traffic light geolocation from the vehicle transceiver 208 or the vehicle memory 210, and may also obtain the real-time vehicle information from the VCU 214. As described above, the real-time vehicle information may include real-time (or current) vehicle speed, a vehicle movement direction, a vehicle geolocation, and/or the like. Responsive to obtaining the information described above, the vehicle processor 212 may correlate the SPaT information 312 and the traffic light geolocation with the real-time vehicle information to determine whether the vehicle 202 will cross the traffic light 104 in the green phase if the vehicle 202 continues to travel at the current speed (or in the same direction of travel). Responsive to determining that the vehicle 202 may not cross the traffic light 104 in the green phase based on the correlation, the vehicle processor 212 may generate a command signal. The vehicle processor 212 may then output/transmit the generated command signal to the infotainment system 216 and/or the VCU 214.

Responsive to obtaining the command signal from the vehicle processor 212, the infotainment system 216 may output (audibly or visually) a predefined message based on the command signal. For example, as shown in view 402 of FIG. 4, the infotainment system 216 may display “Decrease vehicle speed to pass the next traffic light in green phase,” Responsive to hearing or viewing the message, the vehicle driver (not shown) may decrease the vehicle speed (while taking in account existing traffic and obeying local rules and laws) to cross the traffic light 104 in the green phase. In this manner, the system 200 assists the vehicle 202 in crossing the traffic light 104 in the green phase, thereby conserving vehicle energy that may have been spent if the vehicle 202 were to wait at the traffic light 104 in the red phase. Although the example above describes an aspect where the command signal indicates the vehicle driver to decrease vehicle speed, in some aspects, the command signal may indicate the vehicle driver to increase vehicle speed and/or change vehicle movement direction (e.g., take a detour) to assist the vehicle 202 in crossing the traffic light 104 in the green phase, while taking in account existing traffic and obeying local rules and laws.

In further aspects, when the vehicle 202 may be a fully or a partially autonomous vehicle, responsive to obtaining the command signal from the vehicle processor 212, the VCU 214 may autonomously control vehicle movement (e.g., decrease or increase vehicle speed or change vehicle movement direction, while obeying all local rules and laws) such that the vehicle 202 may cross the traffic light 104 in the green phase. In some embodiments, the vehicle may be aware of certain local traffic laws, such as speed limit, and take such into consideration in generating the output. For instance, the system 200 may incorporate a maximum lawful speed in the output, or recommend a decrease in speed when the vehicle will not be able to pass the next light in a green phase without exceeding the local speed limit.

Although the description above describes an aspect where the system processor 220 generates the trained machine module 230 and predicts the SPaT information 312 for the traffic light 104 by executing the instructions stored in the trained machine module 230, a person ordinarily skilled in the art may appreciate that the system processor 220 may generate similar trained machine modules for a plurality of traffic lights (one trained machine module for each traffic light). The system processor 220 may then determine SPaT information associated with each traffic light in a travel route of the vehicle 202, and may transmit the determined SPaT information to the vehicle 202. The vehicle 202 may then control vehicle movement, as described above, based on the SPaT information such that the vehicle 202 may cross most (or all) of the traffic lights in the vehicle's route in respective green phases.

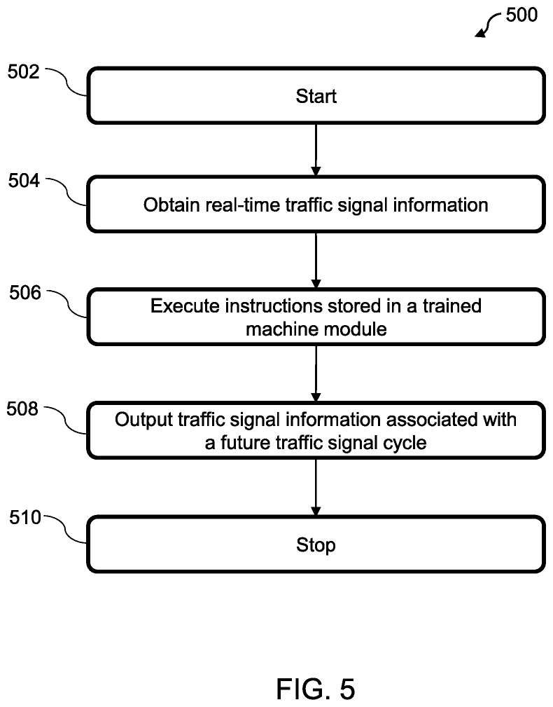

FIG. 5 depicts a flow diagram of an example method 500 for predicting SPaT in accordance with the present disclosure. FIG. 5 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 500 starts at step 502. At step 504, the method 500 may include obtaining, by the system processor 220, the real-time traffic signal information from the server 206 or the traffic light controller. At step 506, the method 500 may include executing, by the system processor 220, instructions stored in the trained machine module 230 to predict the SPaT 312 based on the real-time traffic signal information. At step 508, the method 500 may include outputting, by the system processor 220, the SPaT 312 to the vehicle 202.

The method 500 may end at step 510.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
a system transceiver configured to:
receive historical traffic signal information associated with a traffic light; and
receive real-time traffic signal information associated with the traffic light for a first predefined count of recent traffic signal cycles;
a system memory configured to store a training data and a trained machine model, wherein the trained machine model is trained using the training data that comprises the historical traffic signal information;
a system processor communicatively coupled with the system transceiver and the system memory, wherein the system processor is configured to:
obtain the real-time traffic signal information from the system transceiver;
execute instructions stored in the trained machine model to predict traffic signal information associated with a future traffic signal cycle based on the real-time traffic signal information; and
output the traffic signal information associated with the future traffic signal cycle.

2. The system of claim 1, wherein each of the historical traffic signal information, the real-time traffic signal information and the traffic signal information associated with the future traffic signal cycle comprises information associated with traffic signal phase and timing (SPaT) associated with each traffic signal cycle.

3. The system of claim 1, wherein the historical traffic signal information is associated with a second predefined count of traffic signal cycles, and wherein the second predefined count of traffic signal cycles is greater than the first predefined count of recent traffic signal cycles.

4. The system of claim 1, wherein the system processor is further configured to generate the trained machine model by using the training data and a Gaussian Process Regression (GPR) supervised machine learning algorithm.

5. The system of claim 1, wherein the system transceiver receives the historical traffic signal information and the real-time traffic signal information from a traffic light control server.

6. The system of claim 1, wherein the system processor outputs the traffic signal information associated with the future traffic signal cycle to a vehicle.

7. A vehicle comprising:
a vehicle transceiver configured to receive traffic signal information associated with a future traffic signal cycle for a traffic light from a server, wherein the traffic signal information associated with the future traffic signal cycle is based on historical traffic signal information associated with the traffic light and real-time traffic signal information associated with the traffic light for a first predefined count of recent traffic signal cycles;
a vehicle control unit configured to determine real-time vehicle information; and
a vehicle processor communicatively coupled with the vehicle transceiver and the vehicle control unit, wherein the vehicle processor is configured to:
obtain the traffic signal information associated with the future traffic signal cycle from the vehicle transceiver and the real-time vehicle information from the vehicle control unit;
generate a command signal based on the traffic signal information and the real-time vehicle information; and
output the command signal.

8. The vehicle of claim 7, wherein the historical traffic signal information is associated with a second predefined count of traffic signal cycles, wherein the second predefined count of traffic signal cycles is greater than the first predefined count of recent traffic signal cycles.

9. The vehicle of claim 7, each of the historical traffic signal information, the real-time traffic signal information and the traffic signal information associated with the future traffic signal cycle comprises information associated with traffic signal phase and timing (SPaT) associated with each traffic signal cycle.

10. The vehicle of claim 7, wherein the traffic signal information associated with the future traffic signal cycle is determined using a Gaussian Process Regression (GPR) supervised machine learning algorithm.

11. The vehicle of claim 7, wherein the real-time vehicle information comprises a current vehicle speed and a direction of vehicle movement.

12. The vehicle of claim 7, wherein the vehicle processor is further configured to:
correlate the traffic signal information associated with the future traffic signal cycle with the real-time vehicle information; and
generate the command signal based on the correlation.

13. The vehicle of claim 7, wherein the vehicle processor outputs the command signal to a vehicle infotainment system, and wherein the vehicle infotainment system outputs a predefined message responsive to receiving the command signal.

14. The vehicle of claim 7, wherein the vehicle processor outputs the command signal to the vehicle control unit, wherein the vehicle control unit autonomously controls vehicle movement responsive to receiving the command signal.

15. A method comprising:
obtaining, by a processor, real-time traffic signal information, wherein the real-time traffic signal information is associated with a traffic light for a first predefined count of recent traffic signal cycles;
executing, by the processor, instructions stored in a trained machine model to predict traffic signal information associated with a future traffic signal cycle based on the real-time traffic signal information, wherein the trained machine model is trained using a training data that comprises historical traffic signal information associated with the traffic light; and
outputting, by the processor, the traffic signal information associated with the future traffic signal cycle.

16. The method of claim 15, wherein each of the historical traffic signal information, the real-time traffic signal information and the traffic signal information associated with the future traffic signal cycle comprises information associated with traffic signal phase and timing (SPaT) associated with each traffic signal cycle.

17. The method of claim 15, wherein the historical traffic signal information is associated with a second predefined count of traffic signal cycles, and wherein the second predefined count of traffic signal cycles is greater than the first predefined count of recent traffic signal cycles.

18. The method of claim 15 further comprising generating the trained machine model by using the training data and a Gaussian Process Regression (GPR) supervised machine learning algorithm.

19. The method of claim 15, wherein obtaining the real-time traffic signal information comprises obtaining the real-time traffic signal information from a traffic light control server.

20. The method of claim 15, wherein outputting the traffic signal information comprises outputting the traffic signal information to a vehicle.
